(19) United States
(12) Patent Application Publication
(10) Pub. No.: US 2021/0312864 A1
(43) Pub. Date: Oct. 7, 2021

(54) PIXEL CIRCUIT AND DISPLAY PANEL

(71) Applicant: WUHAN CHINA STAR OPTOELECTRONICS SEMICONDUCTOR DISPLAY TECHNOLOGY CO., LTD., Wuhan (CN)

(72) Inventor: Yuan ZHENG, Wuhan (CN)

(21) Appl. No.: 16/766,720

(22) PCT Filed: Apr. 7, 2020
(86) PCT No.: PCT/CN2020/083575

§ 371 Date: May 25, 2020

(30) Foreign Application Priority Data
Mar. 12, 2020 (CN) 202010168684.1

(51) Int. Cl. G09G 3/3258; G09G 3/3275

(52) U.S. Cl. CPC G09G 3/3258; G09G 2300/0842; G09G 3/3275

(57) ABSTRACT

A pixel circuit is provided and has a data writing module, a driving module, a first light-emitting control module, a second light-emitting control module, a light-emitting module, a storage module, a compensation module, and a reset module. In the pixel circuit provided by the present application, the compensation module can independently compensate a threshold voltage of the driving module during a working period of the compensation signal, which is not limited to the working period of the data writing module, and is applicable to relatively high frequency pixel driving.

### FIELD OF DISCLOSURE

The present application relates to displays, in particular to a field of higher frequency display technology, and in particular to a pixel circuit.

### BACKGROUND OF DISCLOSURE

At present, development of a display industry is changing rapidly, and display applications have also been integrated into all aspects of people's lives, but homogenization of products is becoming more and more serious. And, consumers are increasingly demanding high-quality displays. Therefore, a higher frequency display has been sought after by consumers in the high-end display field. Among them, the higher frequency display was mainly concentrated in fields of professional grade and game applications in the early days. The demand for higher-frequency mobile phone applications is also increasing. Correspondingly, higher frequency displays can bring a smoother user experience.

Current main display modes are: liquid crystal display (LCD) display mode and organic light-emitting diode (OLED, organic light-emitting semiconductor) display mode, difficulty of the two in the higher frequency drive is different. The current-driven display represented by the OLED display mode is more difficult to achieve higher frequency driving than the LCD display mode. In order to ensure display quality, the current OLED display mostly uses a compensation circuit design, and a limitation of the working time of the compensation circuit makes the application of higher frequency driving difficult. In higher frequency driving applications, the scanning time of each line of pixels is compressed, and the compensation time is compressed, causing the compensation effect to decrease, resulting in poor display quality.

### SUMMARY OF DISCLOSURE

The present application provides a pixel circuit, which solves a problem that a threshold voltage compensation of the pixel circuit in higher frequency applications is limited by the line scan time, resulting in a decrease in the threshold voltage compensation effect.

In a first aspect, the present application provides a pixel circuit comprising a data writing module, a driving module, a first light-emitting control module, a second light-emitting control module, a light-emitting module, a storage module, a compensation module, and a reset module. The data writing module is configured to control a writing of a data signal according to a scanning signal. The driving module is connected to an output end of the data writing module and is configured to access and output a driving signal according to a control of the data signal. The first light-emitting control module is connected to an input end of the driving module and a positive power signal, and is configured to output the positive power signal input according to a first light-emitting control signal. The second light-emitting control module is connected to an output end of the driving module, and is configured to output the driving signal connected according to a second light-emitting control signal. The light-emitting module is connected to an output end of the second light-emitting control module and a negative power signal, and is configured for pixel light-emitting. The storage module is connected to the input end of the driving module and the output end of the data writing module, and is configured to store a threshold voltage of the driving module. The compensation module is connected to the storage module, the output end of the input writing module, and a reference voltage signal, and is configured to adjust the threshold voltage of the driving module according to a compensation signal. The reset module is connected to an initial voltage signal, an input end of the light-emitting module, and the output end of the second light-emitting control module, and is configured to reset the light-emitting module according to the compensation signal, wherein a duty cycle of the scanning signal and the compensation signal are different in timing.

Based on the first aspect, in a first embodiment of the first aspect, the pixel circuit further includes a voltage dividing module, wherein an end of the voltage dividing module is connected to the positive voltage signal, another end of the voltage dividing module is connected to an output end of the first light-emitting control module and the input end of the driving module; and wherein the voltage dividing module is configured to divide a potential of the input end of the driving module.

Based on the first embodiment of the first aspect, in the second embodiment of the first aspect, the data writing module includes a first thin-film transistor, wherein the data signal is connected to a source of the first thin-film transistor, and the scan signal is connected to a gate of the first thin-film transistor.

Based on the second embodiment of the first aspect, in the third embodiment of the first aspect, the driving module includes a second thin-film transistor, wherein a gate of the second thin-film transistor is connected to a drain of the first thin-film transistor; a source of the second thin-film transistor is connected to an output end of the first light-emitting control module; and a drain of the second thin-film transistor is connected to an input end of the second light-emitting control module.

Based on the third embodiment of the first aspect, in the fourth embodiment of the first aspect, the first light emitting control module includes a third thin-film transistor, wherein the positive power supply signal is connected to a source of the third thin-film transistor; the first light emitting control signal is connected to a gate of the third thin-film transistor; and a drain of the third thin-film transistor is connected to a source of the second thin-film transistor.

Based on the fourth embodiment of the first aspect, in the fifth embodiment of the first aspect, the second light emitting control module includes a fourth thin-film transistor, wherein a source of the fourth thin-film transistor is connected to the drain of the second thin-film transistor; a gate of the fourth thin-film transistor is connected to the second light-emitting control signal; and a drain of the fourth thin-film transistor is connected to the input end of the light emitting module.

Based on the fifth embodiment of the first aspect, in the sixth embodiment of the first aspect, the light emitting module includes a light emitting device, wherein an input end of the light emitting device is connected to the drain of the fourth thin-film transistor; and an output end of the light emitting device is connected to the negative power signal.

Based on the sixth embodiment of the first aspect, in the seventh embodiment of the first aspect, the storage module includes a storage capacitor; wherein a first end of the storage capacitor is connected to the drain of the first thin-film transistor and the gate of the second thin-film transistor, and a second end of the storage capacitor is connected to the source of the second thin-film transistor and the drain of the third thin-film transistor.

Based on the seventh embodiment of the first aspect, in the eighth embodiment of the first aspect, the compensation module includes a fifth thin-film transistor, wherein a gate of the fifth thin-film transistor is connected to the compensation signal; a source of the fifth thin-film transistor is connected to the reference voltage signal; and a drain of the fifth thin-film transistor is connected to the first end of the storage capacitor.

Based on the eighth embodiment of the first aspect, in the ninth embodiment of the first aspect, the reset module includes a sixth thin-film transistor; wherein a source of the sixth thin-film transistor is connected to the initial voltage signal; a gate of the sixth thin-film transistor is connected to the compensation signal; and a drain of the sixth thin-film transistor is connected to the drain of the fourth thin-film transistor.

In the pixel circuit provided by the present application, the compensation module can independently compensate a threshold voltage of the driving module during a working period of the compensation signal, which is not limited to the working period of the data writing module, can improve the compensation effect of its threshold voltage, and is applicable to relatively high frequency pixel driving.

### DESCRIPTION OF DRAWINGS

FIG. 1 is a circuit schematic diagram of a pixel circuit in a conventional technical solution.

FIG. 2 is a timing diagram of the pixel circuit in FIG. 1.

FIG. 3 is a schematic diagram of a first structure of a pixel circuit provided by an embodiment of the present application.

FIG. 4 is a second schematic structural diagram of a pixel circuit provided by an embodiment of the present application.

FIG. 5 is a circuit schematic diagram of the pixel circuit in FIG. 4.

FIG. 6 is a timing diagram of the pixel circuit in FIG. 5.

FIG. 7 is a timing diagram of the multi-line operation of the pixel circuit in FIG. 5.

### DETAILED DESCRIPTION OF PREFERRED EMBODIMENTS

In order to make the purpose, technical solutions and effects of this application more clear and unambiguous, the present application will be described in further detail below with reference to the accompanying drawings and examples. It should be understood that the specific embodiments described herein are only used to explain the present application, and are not used to limit the present application.

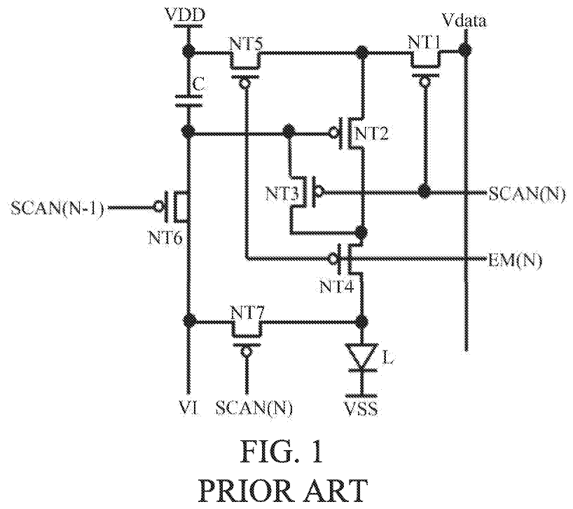

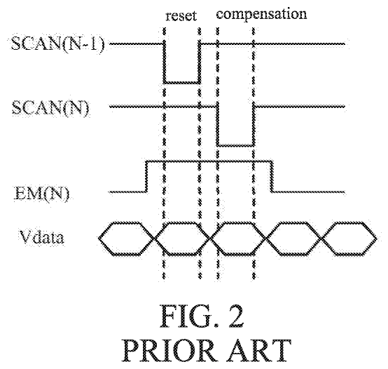

In order to better understand the intent of the disclosure of the present application, a pixel circuit in the conventional technical solution will now be analyzed in conjunction with FIGS. 1 and 2 as follows:

The pixel circuit is a commonly used 7T1C topology, and its working process can be divided into the following three stages:

Reset stage: a scan signal SCAN (N-1) of a N-1 stage is low, a transistor NT6 is turned on, a low potential signal VI is connected to the pixel circuit, and a capacitor C starts to discharge.

Data writing stage: a N-th scan signal SCAN (N) is low, a transistor NT3 and a transistor NT1 are turned on, a source and a drain of a transistor NT2 are short-circuited, and the transistor NT2 acts as a diode, until a gate potential of the transistor NT2 becomes the voltage Vdata of the data signal and an absolute value of the threshold voltage of the transistor NT2; at the same time, a transistor NT7 is turned on to reset the light emitting device L.

Light-emitting stage: a light-emitting control signal EM (N) is low, a transistor NT4 and a transistor NT5 are turned on, and the light-emitting device L performs pixel display.

In summary, data writing in the pixel circuit of the 7T1C topology and the threshold voltage compensation of the transistor NT2 are performed simultaneously. That is, the threshold voltage compensation is limited to a time period of data writing. Therefore, when driving at a higher frequency, the time period of data writing will be shortened. Correspondingly, the time period of threshold voltage compensation is shortened accordingly, which reduces an effect of threshold voltage compensation.

In the pixel circuit provided by the present application, the compensation module can independently compensate the threshold voltage of the driving module during the working period of the compensation signal, which is not limited to the working period of the data writing module, which can improve the compensation effect of the threshold voltage , Suitable for driving higher frequency pixels.

In the pixel circuit provided by the present application, the compensation module can independently compensate a threshold voltage of the driving module during a working period of the compensation signal, which is not limited to the working period of the data writing module, can improve the compensation effect of its threshold voltage, and is applicable to relatively high frequency pixel driving. The following analysis will be performed in conjunction with the embodiment:

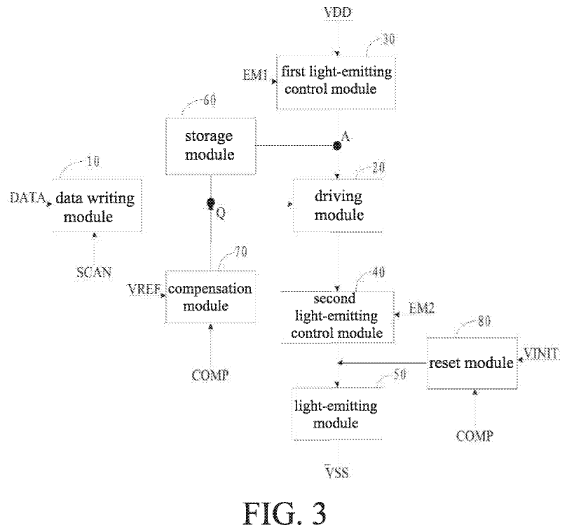

As shown in FIG. 3, the present application provides a pixel circuit comprising a data writing module 10, a driving module 20, a first light-emitting control module 30, a second light-emitting control module 40, a light-emitting module 50, a storage module 60, a compensation module 70, and a reset module 80. The data writing module 10 is configured to control a writing of a data signal DATA according to a scanning signal SCAN. The driving module 20 is connected to an output end of the data writing module 10 and is configured to access and output a driving signal according to a control of the data signal DATA. The first light-emitting control module 30 is connected to an input end of the driving module 20 and a positive power signal VDD, and is configured to output the positive power signal VDD input according to a first light-emitting control signal EM1. The second light-emitting control module 40 is connected to an output end of the driving module 20, and is configured to output the driving signal connected according to a second light-emitting control signal EM2. The light-emitting module 50 is connected to an output end of the second light-emitting control module 40 and a negative power signal VSS, and is configured for pixel light-emitting. The storage module 60 is connected to the input end of the driving module 20 and the output end of the data writing module 10, and is configured to store a threshold voltage of the driving module 20. The compensation module 70 is connected to the storage module 60, the output end of the input writing module, and a reference voltage signal VREF, and is configured to adjust the threshold voltage of the driving module 20 according to a compensation signal COMP. The reset module 80 is connected to an initial voltage signal VINIT, an input end of the light-emitting module 50, and the output end of the second light-emitting control module 40, and is configured to reset the light-emitting module 50 according to the compensation signal COMP, wherein a duty cycle of the scanning signal SCAN and the compensation signal COMP are different in timing.

It should be noted that the data writing module 10 and the compensation module 70 are configured as two independent modules, and both can adjust the storage module 60. Further, a duty cycle of the scan signal SCAN and a duty cycle of the compensation signal COMP that sequentially control the two modules is not the same. Therefore, the threshold voltage of the compensation module 70 for the driving module 20 stored in the storage module 60 may not be limited to the duty cycle of the data writing module 10. Therefore, the threshold voltage of the driving module 20 can be better compensated, and the time and value of the compensation can also be controlled, which is suitable for driving relatively high frequency pixels.

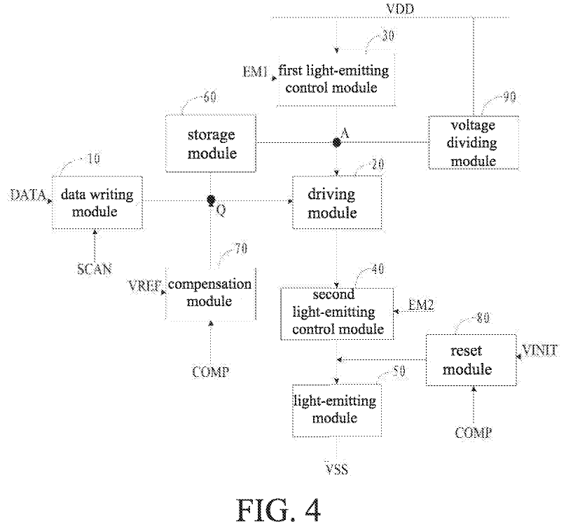

As shown in FIG. 4, in one of the embodiments, the pixel circuit further includes a voltage dividing module 90, wherein an end of the voltage dividing module 90 is connected to the positive voltage signal, another end of the voltage dividing module 90 is connected to an output end of the first light-emitting control module 30 and the input end of the driving module 20; and wherein the voltage dividing module 90 is configured to divide a potential of the input end of the driving module 20.

It should be noted that a function of the voltage dividing module 90 may be to adjust the potential of the input end of the driving module 20, and then the threshold voltage of the driving module 20 may be adjusted.

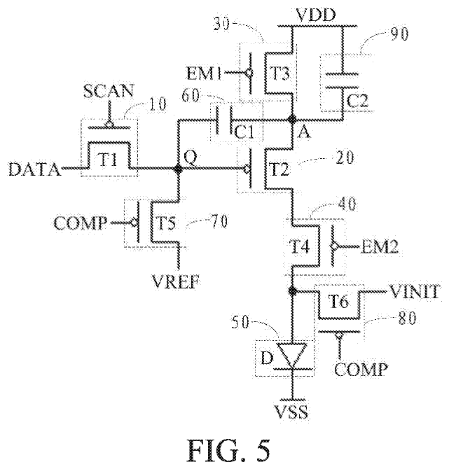

As shown in FIG. 5, in one of the embodiments, the data writing module 10 includes a first thin-film transistor T1, wherein the data signal DATA is connected to a source of the first thin-film transistor T1, and the scan signal SCAN is connected to a gate of the first thin-film transistor T1.

As shown in FIG. 5, in one of the embodiments, the driving module 20 includes a second thin-film transistor T2, wherein a gate of the second thin-film transistor T2 is connected to a drain of the first thin-film transistor T1; a source of the second thin-film transistor T2 is connected to an output end of the first light-emitting control module 30; and a drain of the second thin-film transistor T2 is connected to an input end of the second light-emitting control module 40.

As shown in FIG. 5, in one of the embodiments, the first light emitting control module 30 includes a third thin-film transistor T3, wherein the positive power supply signal VDD is connected to a source of the third thin-film transistor T3; the first light emitting control signal EM1 is connected to a gate of the third thin-film transistor T3; and a drain of the third thin-film transistor T3 is connected to a source of the second thin-film transistor T2.

As shown in FIG. 5, in one of the embodiments, the second light emitting control module 40 includes a fourth thin-film transistor T4, wherein a source of the fourth thin-film transistor T4 is connected to the drain of the second thin-film transistor T2; a gate of the fourth thin-film transistor T4 is connected to the second light-emitting control signal EM2; and a drain of the fourth thin-film transistor T4 is connected to the input end of the light emitting module 50.

As shown in FIG. 5, in one of the embodiments, the light emitting module 50 includes a light emitting device D, wherein an input end of the light emitting device D is connected to the drain of the fourth thin-film transistor T4; and an output end of the light emitting device D is connected to the negative power signal VSS.

It should be noted that the light-emitting device D may be, but not limited to, OLED, or self-luminous components such as LED.

As shown in FIG. 5, in one of the embodiments, the storage module 60 includes a storage capacitor; wherein a first end of the storage capacitor is connected to the drain of the first thin-film transistor T1 and the gate of the second thin-film transistor T2, and a second end of the storage capacitor is connected to the source of the second thin-film transistor T2 and the drain of the third thin-film transistor T3.

As shown in FIG. 5, in one of the embodiments, the compensation module 70 includes a fifth thin-film transistor T5, wherein a gate of the fifth thin-film transistor T5 is connected to the compensation signal COMP; a source of the fifth thin-film transistor T5 is connected to the reference voltage signal VREF; and a drain of the fifth thin-film transistor T5 is connected to the first end of the storage capacitor.

As shown in FIG. 5, in one of the embodiments, the reset module 80 includes a sixth thin-film transistor T6; wherein a source of the sixth thin-film transistor T6 is connected to the initial voltage signal VINIT; a gate of the sixth thin-film transistor T6 is connected to the compensation signal COMP; and a drain of the sixth thin-film transistor T6 is connected to the drain of the fourth thin-film transistor T4.

As shown in FIG. 5, in one of the embodiments, the voltage dividing module 90 includes a voltage dividing capacitor; wherein a first end of the voltage dividing capacitor is connected to the positive power signal VDD; and a second end of the voltage dividing capacitor is connected to the second end of the storage capacitor.

As shown in FIG. 5, in one of the embodiments, the first thin-film transistor T1, the second thin-film transistor T2, the third thin-film transistor T3, the fourth thin-film transistor T4, the fifth thin-film transistor T5, and the sixth thin-film transistor T6 are all P-type thin-film transistors.

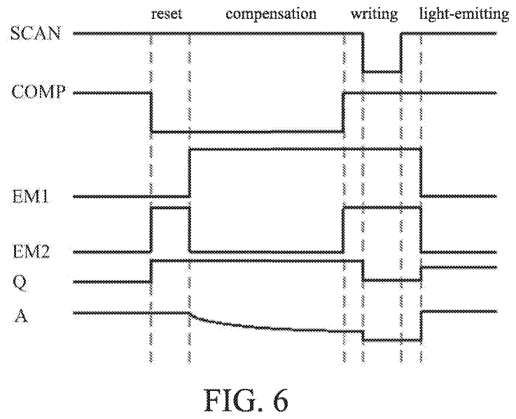

As shown in FIG. 6, a working process of the pixel circuit in this embodiment includes the following stages:

In a reset stage: both the compensation signal COMP and the first light-emitting control signal EM1 are low-potential signals. The third thin-film transistor T3, the fifth thin-film transistor T5, and the sixth thin-film transistor T6 are turned on, so as to reset a first capacitor C1, a second capacitor C2, and the light emitting device D. The fifth thin-film transistor T5 resets a Q point to a potential of the reference voltage signal VREF. The sixth thin-film transistor T6 resets an input end of the light emitting device D to a potential of the initial voltage signal VINIT. At the same time, the third thin-film transistor T3 resets point A to a potential of the power supply positive signal VDD.

In a compensation stage: both the compensation signal COMP and the second light-emitting control signal EM2 are low-potential signals. The second thin-film transistor T2, the fourth thin-film transistor T4, the fifth thin-film transistor T5, and the sixth thin-film transistor T6 are all turned on to charge the first capacitor C1 and the second capacitor C2. The first capacitor C1 stores the threshold voltage Vth of the second thin-film transistor T2. Point Q maintains the potential of the reference voltage signal VREF. The potential at point A is the sum of the potential of the reference voltage signal VREF and the absolute value of the threshold voltage, i.e., VREF+|Vth|.

In a writing stage: a scan signal SCAN is at low potential. The first thin-film transistor T1 is turned on, and the data signal DATA is written to the first capacitor C1. At this time, the Q point is the potential of the data signal DATA, that is, VDATA. The potential at point A becomes VA, which is a source potential of the second thin-film transistor T2. An expression of VA is as follows:

$$VA = ( VDATA - VREF ) \times \frac{C 1}{C 1 + C 2} + VREF + \vert Vth \vert \qquad Expression formula 1$$

In a light-emitting stage: both the first light-emitting control signal EM1 and the second light-emitting control signal EM2 are low-potential signals. The third thin-film transistor T3 and the fourth thin-film transistor T4 are turned on, and the light emitting device D starts to emit light.

An expression of the current flowing through the light emitting device D is as follows:

$${I}_{L E D} = \frac{1}{2} μ {C}_{OX} \frac{W}{L} {( Vgs - Vth )}^{2} \qquad Expression formula 2$$

Bring the Q point potential VDATA and the A point potential, that is, the expression formula 1, into the expression formula two, resulting in expression formula 3 as shown below:

$$Expression formula 3 \\ {I}_{LED} = \frac{1}{2} μ \backslash [ {NoBreaC}_{OX } \frac{W}{L} [ ( VDATA - {( VDATA - VREF ) \times \frac{C 1}{C 1 + C 2} - VREF + \vert Vth \vert ) - \vert Vth \vert ]}^{2}$$

To simplify expression formula 3 to get the following expression formula 4:

$${I}_{L E D} = \frac{1}{2} {μ C}_{O X} {\frac{w}{L} [ ( VDATA - VREF ) \times \frac{C 2}{C 1 + C 2} ]}^{2} \qquad Expression formula 4$$

Where μ is the carrier mobility; C0x is an oxide capacity per unit area; W/L is a width-to-length ratio of the T2 channel of the second thin-film transistor; Vth is the threshold voltage of the second thin-film transistor T2; VREF is the potential of the reference voltage signal; VDATA is the potential of the data signal; Cl is the capacity of the first capacitor; and C2 is the capacity of the second capacitor.

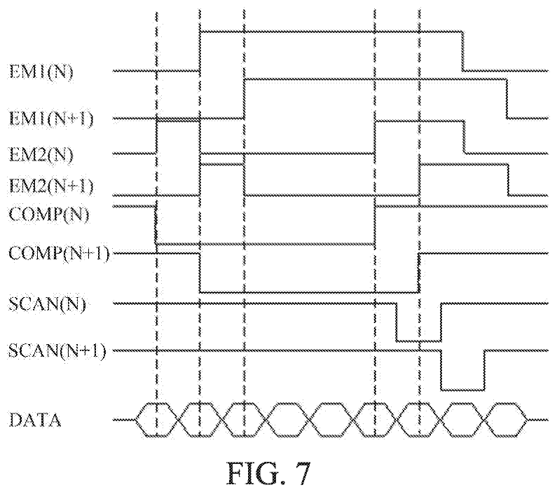

In one of the embodiments, this embodiment provides a display panel, which is applied to the field of self-luminous display. The display panel may include a plurality of rows of pixel circuits in the foregoing embodiment distributed in an array, each row including a plurality of the pixel circuits, as shown in FIG. 7, wherein the pixel circuit of the Nth row is subjected to the first light emission control signal EM1 (N) of the Nth row, the second light emission control signal EM2 (N) of the Nth row, the compensation signal COMP (N) of the Nth row, and the scan signal SCAN (N) of the Nth row N) and the control of the data signal DATA. The compensation stage and the writing stage are independent of each other, and the compensation stage is not limited by the period of the writing stage. Similarly, the pixel circuit is controlled by the first light emission control signal EM1(N+1) in the N+1 th row, the second light emission control signal EM2(N+1) in the N+1th row, the compensation signal COMP (N+1) in the N+1th row, the Nth+1 line scan signal SCAN(N+1), and data signal DATA. The compensation stage and the writing stage are independent of each other, and the compensation stage is not limited by the period of the writing stage. In addition, the pixel circuit in the Nth row and the pixel circuit in the N+1th row can also be performed simultaneously without mutual influence. Therefore, the display panel provided in this example is also suitable for higher frequency driving applications and has better compensation effect.

It can be understood that, for those of ordinary skill in the art, equivalent replacements or changes can be made according to the technical solutions and inventive concepts of the present application, and all such changes or replacements should fall within the protection scope of the claims appended to the present application.

1. A pixel circuit, comprising:
a data writing module configured to control a writing of a data signal according to a scanning signal;
a driving module connected to an output end of the data writing module and configured to access and output a driving signal according to a control of the data signal;
a first light-emitting control module connected to an input end of the driving module and a positive power signal, and configured to output the positive power signal input according to a first light-emitting control signal;
a second light-emitting control module connected to an output end of the driving module, and configured to output the driving signal connected according to a second light-emitting control signal;
a light-emitting module connected to an output end of the second light-emitting control module and a negative power signal, and configured for pixel light-emitting;
a storage module connected to the input end of the driving module and the output end of the data writing module, and configured to store a threshold voltage of the driving module;
a compensation module connected to the storage module, the output end of the input writing module, and a reference voltage signal, and configured to adjust the threshold voltage of the driving module according to a compensation signal;
a reset module connected to an initial voltage signal, an input end of the light-emitting module, and the output end of the second light-emitting control module, and configured to reset the light-emitting module according to the compensation signal; and
a voltage dividing module, wherein an end of the voltage dividing module is connected to the positive voltage signal, another end of the voltage dividing module is connected to an output end of the first light-emitting control module and the input end of the driving module; and wherein the voltage dividing module is configured to divide a potential of the input end of the driving module,
wherein a duty cycle of the scanning signal and the compensation signal are different in timing.

2. The pixel circuit according to claim 1, wherein the data writing module includes a first thin-film transistor,
wherein the data signal is connected to a source of the first thin-film transistor, and the scan signal is connected to a gate of the first thin-film transistor.

3. The pixel circuit according to claim 2, wherein the driving module includes a second thin-film transistor,
wherein a gate of the second thin-film transistor is connected to a drain of the first thin-film transistor; a source of the second thin-film transistor is connected to an output end of the first light-emitting control module; and a drain of the second thin-film transistor is connected to an input end of the second light-emitting control module.

4. The pixel circuit according to claim 3, wherein the first light emitting control module includes a third thin-film transistor,
wherein the positive power supply signal is connected to a source of the third thin-film transistor; the first light emitting control signal is connected to a gate of the third thin-film transistor; and a drain of the third thin-film transistor is connected to a source of the second thin-film transistor.

5. The pixel circuit according to claim 4, wherein the second light emitting control module includes a fourth thin-film transistor,
wherein a source of the fourth thin-film transistor is connected to the drain of the second thin-film transistor; a gate of the fourth thin-film transistor is connected to the second light-emitting control signal; and a drain of the fourth thin-film transistor is connected to the input end of the light emitting module.

6. The pixel circuit according to claim 5, wherein the light emitting module includes a light emitting device,
wherein an input end of the light emitting device is connected to the drain of the fourth thin-film transistor; and an output end of the light emitting device is connected to the negative power signal.

7. The pixel circuit according to claim 6, wherein the storage module includes a storage capacitor;
wherein a first end of the storage capacitor is connected to the drain of the first thin-film transistor and the gate of the second thin-film transistor, and a second end of the storage capacitor is connected to the source of the second thin-film transistor and the drain of the third thin-film transistor.

8. The pixel circuit according to claim 7, wherein the compensation module includes a fifth thin-film transistor,
wherein a gate of the fifth thin-film transistor is connected to the compensation signal; a source of the fifth thin-film transistor is connected to the reference voltage signal; and a drain of the fifth thin-film transistor is connected to the first end of the storage capacitor.

9. The pixel circuit according to claim 8, wherein the reset module includes a sixth thin-film transistor;
wherein a source of the sixth thin-film transistor is connected to the initial voltage signal; a gate of the sixth thin-film transistor is connected to the compensation signal; and a drain of the sixth thin-film transistor is connected to the drain of the fourth thin-film transistor.

10. A pixel circuit, comprising:
a data writing module configured to control a writing of a data signal according to a scanning signal;
a driving module connected to an output end of the data writing module and configured to access and output a driving signal according to a control of the data signal;
a first light-emitting control module connected to an input end of the driving module and a positive power signal, and configured to output the positive power signal input according to a first light-emitting control signal;
a second light-emitting control module connected to an output end of the driving module, and configured to output the driving signal connected according to a second light-emitting control signal;
a light-emitting module connected to an output end of the second light-emitting control module and a negative power signal, and configured for pixel light-emitting;
a storage module connected to the input end of the driving module and the output end of the data writing module, and configured to store a threshold voltage of the driving module;
a compensation module connected to the storage module, the output end of the input writing module, and a reference voltage signal, and configured to adjust the threshold voltage of the driving module according to a compensation signal; and
a reset module connected to an initial voltage signal, an input end of the light-emitting module, and the output end of the second light-emitting control module, and configured to reset the light-emitting module according to the compensation signal;
wherein a duty cycle of the scanning signal and the compensation signal are different in timing.

11. The pixel circuit according to claim 10, wherein the data writing module includes a first thin-film transistor,
wherein the data signal is connected to a source of the first thin-film transistor; the scan signal is connected to a gate of the first thin-film transistor.

12. The pixel circuit according to claim 11, wherein the driving module includes a second thin-film transistor,
wherein a gate of the second thin-film transistor is connected to a drain of the first thin-film transistor; a source of the second thin-film transistor is connected to an output end of the first light-emitting control module; and a drain of the second thin-film transistor is connected to an input end of the second light-emitting control module.

13. The pixel circuit according to claim 12, wherein the first light emitting control module includes a third thin-film transistor,
wherein the positive power supply signal is connected to a source of the third thin-film transistor; the first light emitting control signal is connected to a gate of the third thin-film transistor; and a drain of the third thin-film transistor is connected to a source of the second thin-film transistor.

14. The pixel circuit according to claim 13, wherein the second light emitting control module includes a fourth thin-film transistor,
wherein a source of the fourth thin-film transistor is connected to the drain of the second thin-film transistor; a gate of the fourth thin-film transistor is connected to the second light-emitting control signal; and a drain of the fourth thin-film transistor is connected to the input end of the light emitting module.

15. The pixel circuit according to claim 14, wherein the light emitting module includes a light emitting device,
wherein an input end of the light emitting device is connected to the drain of the fourth thin-film transistor; and an output end of the light emitting device is connected to the negative power signal.

16. The pixel circuit according to claim 15, wherein the storage module includes a storage capacitor;
wherein a first end of the storage capacitor is connected to the drain of the first thin-film transistor and the gate of the second thin-film transistor, and a second end of the storage capacitor is connected to the source of the second thin-film transistor and the drain of the third thin-film transistor.

17. The pixel circuit according to claim 16, wherein the compensation module includes a fifth thin-film transistor,
wherein a gate of the fifth thin-film transistor is connected to the compensation signal; a source of the fifth thin-film transistor is connected to the reference voltage signal; and a drain of the fifth thin-film transistor is connected to the first end of the storage capacitor.

18. The pixel circuit according to claim 17, wherein the reset module includes a sixth thin-film transistor;
wherein a source of the sixth thin-film transistor is connected to the initial voltage signal; a gate of the sixth thin-film transistor is connected to the compensation signal; and a drain of the sixth thin-film transistor is connected to the drain of the fourth thin-film transistor.

19. The pixel circuit according to claim 18, wherein the first thin-film transistor, the second thin-film transistor, the third thin-film transistor, the fourth thin-film transistor, the fifth thin-film transistor, and the sixth thin-film transistor are all P-type thin-film transistors.

20. A display panel comprising the pixel circuit according to claim 10.
